(19) United States
(12) Patent Application Publication
(10) Pub. No.: US 2008/0116309 A1
(43) Pub. Date: May 22, 2008

(54) Webbing Retractor

(75) Inventors: Hitoshi Takamatsu, Aichi (JP); Masaki Yasuda, Aichi (JP)

Correspondence Address: ROBERTS, MLOTKOWSKI & HOBBES, P. O. BOX 10064, MCLEAN, VA, 22102-8064, US

(73) Assignee: KABUSHIKI KAISHA TOKAI-RIKA-DENKI-SEISAKUSHO, Niwa-gun, Aichi (JP)

(21) Appl. No.: 11/718,393

(22) PCT Filed: Nov. 11, 2005
(86) PCT No.: PCT/JP05/21180

§ 371 Date: May 1, 2007

(30) Foreign Application Priority Data
Nov. 11, 2004 (JP) 2004-328114

(51) Int. Cl. B60R 22/46

(52) U.S. Cl. 242/374

(57) ABSTRACT

In a webbing retractor (10), a gear case (70), which rotatably supports another end of a shaft (162) of a lock pawl (160), is fixed to a frame (12) via engaging pins (182, 184). Namely, the engaging pin (182) is fit-together with an engaging hole (186) of a leg plate (16), and the engaging pin (184) is fit-together with an engaging hole (188) at a side of a sliding locus of a rack bar (68) which side is opposite a side at which the engaging pin (182) is located, and at a position which is displaced further in a sliding direction of the rack bar (68) than the engaging pin (182). In accordance with the webbing retractor (10), even if the gear case (70) attempts to be displaced with respect to the leg plate (16), the engaging pins (182, 184) resist this, and displacement of the gear case (70) can be prevented. Namely, changes in a supporting position of a specific member, which is provided in a vicinity of a sliding locus of a sliding member of a pretensioner, can be suppressed or prevented.

### TECHNICAL FIELD

The present invention relates to a webbing retractor which takes-up and accommodates a webbing belt which restrains the body of a vehicle occupant.

### PRIOR ART

A seat belt device, which, by an elongated, strip-shaped webbing belt, restrains the body of a vehicle occupant seated on a seat of a vehicle, is equipped with a webbing retractor which is fixed to a vehicle body at the side of the seat. The webbing retractor has a spool whose axial direction runs substantially along the vehicle longitudinal direction for example. The longitudinal direction proximal end side of the webbing belt is anchored on the spool, and the webbing belt is housed in a state of being wound in layers around the outer peripheral portion of the spool.

The webbing belt, which is accommodated in a state of being wound around the spool in this way, is pulled-out, and the pulled-out webbing belt is applied around the body of a vehicle occupant. In this state, due to a tongue plate, which is provided at a predetermined region of the webbing belt, being held by a buckle device which is provided at the side of the seat opposite the side at which the webbing retractor is provided, the webbing belt is applied to the body of the vehicle occupant.

Various mechanisms for reliably holding the body of a vehicle occupant by the webbing belt in a state of rapid deceleration of the vehicle, are provided at webbing retractors.

As shown in Japanese Patent Application Laid-Open (JP-A) No. 2000-302010, there is a lock mechanism as one mechanism for reliably holding the body of a vehicle occupant by a webbing belt in a state of rapid deceleration of a vehicle. In a case in which the vehicle enters into state of rapid deceleration, the lock mechanism causes a pawl, which is provided at the axial direction other end side of a spool, to mesh together with an internal ratchet which is formed at a frame of a webbing retractor. In this way, rotation of the spool, in the pulling-out direction which is the direction of rotation at the time when the webbing belt is pulled-out, is restricted, and accordingly, the webbing belt is prevented from being pulled-out from the spool.

In this way, even if the body of the vehicle occupant, which is attempting to inertially move substantially toward the front of the vehicle due to the rapid deceleration of the vehicle, pulls on the webbing belt, the webbing-belt is not pulled-out from the spool. Therefore, the body of the vehicle occupant is reliably held by the webbing belt which is applied thereto, and inertial movement of the body of the vehicle occupant substantially toward the front of the vehicle can be restricted.

Further, as described in JP-A No. 2000-313312, there is a pretensioner as a mechanism for reliably holding the body of a vehicle occupant by a webbing belt in a state of rapid deceleration of a vehicle. The pretensioner has a cylinder and a piston. The side of the cylinder which is further toward the floor portion thereof than the piston is connected to a gas generator. At the time of a rapid deceleration of the vehicle, gas, which is suddenly generated in a short time by the gas generator, is supplied into the space at the side of the cylinder further toward the floor portion thereof than the piston, and the piston thereby moves toward the opening end side of the cylinder.

A rack bar is provided integrally with the piston. A pinion gear is provided coaxially and relatively rotatably at the spool so as to correspond to the rack bar. Due to the piston moving toward the opening end side of the cylinder, the rack bar meshes together with the pinion, and rotates the pinion in the take-up direction which is opposite to the aforementioned pull-out direction. The rotation of the pinion in the take-up direction is transmitted to the spool via a clutch, and the spool is rotated in the take-up direction.

Due to the spool being forcibly rotated in the take-up direction in this way, the webbing belt which is pulled-out from the spool is taken-up onto the spool. In this way, looseness in the webbing belt, which is called “slack” or the like for example, is eliminated, and the body of the vehicle occupant can be reliably held by the webbing belt.

The lock mechanism of the webbing retractor disclosed in JP-A No. 2000-302010 is a structure which locks the spool due to the pawl meshing with the teeth of the internal ratchet formed in the frame. In contrast, a structure has also been conceived of which locks the spool by a pawl meshing together with the teeth of an external ratchet formed at the spool.

In the case of such a structure, the pawl must be supported so as to be able to approach and move away from the ratchet teeth of the spool. In order to support such a pawl, a structure has been thought of in which a supporting member, which is for directly supporting the pawl, is mounted to the frame of the webbing retractor.

In assembling such a supporting member to the frame, if the supporting member is provided in the vicinity of a pretensioner such as that disclosed in JP-A No. 2000-302010, there is the possibility that the supporting member may be slightly displaced with respect to the frame due to impact at the time when the pretensioner operates. If the position of the pawl with respect to the frame changes due to such displacement of the supporting member, torsion arises at the axis of swinging of the pawl, and smooth approaching and moving away of the pawl with respect to the ratchet teeth is impeded, and the meshing of the pawl with the ratchet teeth is affected.

### DISCLOSURE OF THE INVENTION

In view of the aforementioned, an object of the present invention is to provide a webbing retractor which can suppress or prevent fluctuations in a supporting position of a specific member which is provided in a vicinity of a locus of sliding of a sliding member of a pretensioner.

A webbing retractor relating to the present invention comprises: a spool supported one of directly and indirectly at a frame, a longitudinal direction proximal end side of webbing belt being anchored on the spool, and the spool taking-up the webbing belt by rotating in a take-up direction which is one direction around an axis of the spool; a pretensioner having at least a sliding member which can slide in a predetermined sliding direction which intersects an axial direction of the spool, and due to the sliding member sliding in the sliding direction, the sliding member connects one of directly and indirectly to the spool and rotates the spool in the take-up direction, the pretensioner causing the sliding member to slide in the sliding direction in a state of rapid deceleration of a vehicle; a supporting member provided at a side of a sliding locus of the sliding member along the axial direction of the spool, and supporting a specific member; and a pair of connecting means, one of the connecting means being provided at a side of the sliding locus along a direction orthogonal to both the axial direction of the spool and the sliding direction, and another of the connecting means being provided at a side of the sliding locus opposite a side at which the one of the connecting means is located, and at a position which is displaced, in the sliding direction of the sliding member, with respect to the one of the connecting means, the connecting means mechanically connecting the supporting member to the frame.

In accordance with the webbing retractor relating to the present invention described above, when an elongated, strip-shaped webbing belt, whose longitudinal direction proximal end side is anchored on the spool, is pulled-out and applied to the body of a vehicle occupant, the body of the vehicle occupant is restrained by the webbing belt.

In this state, when a state of rapid deceleration of the vehicle arises, the pretensioner slides the sliding member in the sliding direction. When the sliding member slides in this way, the spool, to which the sliding member is connected either directly or indirectly, is forcibly rotated in the take-up direction.

Due to the spool being forcibly rotated in the take-up direction in this way, the webbing belt is taken-up onto the spool, and the force restraining the body of the vehicle occupant by the webbing belt increases. In this way, the body of the vehicle occupant, which is attempting to inertially move substantially toward the front of the vehicle due to the rapid deceleration of the vehicle, can be reliably held.

On the other hand, in the webbing retractor relating to the present invention, the supporting member is provided at a side of the sliding locus of the sliding member along the axial direction of the spool. The supporting member is mechanically connected by the pair of connecting means to the frame which directly or indirectly supports the spool (i.e., the supporting member is assembled to the frame).

The specific member, which structures the webbing retractor, is supported at the supporting member which is connected to the frame in this way.

Here, one of the pair of the connecting means is provided at a side of the sliding locus of the sliding member along a direction orthogonal to both the axial direction of the spool and the sliding direction of the sliding member. In contrast, the other of the pair of connecting means is provided at the side of the sliding locus of the sliding member which side is opposite the side at which the one of the connecting means is located, and at a position which is displaced, in the sliding direction of the sliding member, with respect to the one of the connecting means.

By providing the pair of connecting means in this way, even if impact in the sliding direction of the sliding member is applied to the supporting member, the pair of connecting means reliably connect and hold the supporting member to the frame at a predetermined position.

In this way, even if impact such as the aforementioned is applied for example, there is no great change in the positional relationship of the specific member, which is supported by the supporting member, with respect to the frame, and the aforementioned impact does not affect the structure using the specific member.

As described above, the webbing retractor relating to the present invention can suppress or effectively suppress changes in the assembled position of a supporting member with respect to a frame. Changes in the supporting position of a specific member, which is supported by the supporting member, can thereby be suppressed or effectively suppressed. Moreover, such effects can be achieved by the pair of connecting means, even if the mechanical strength of the supporting member is not improved in particular. Thus, the supporting member can be made to be lighter-weight.

### BRIEF DESCRIPTION OF THE DRAWINGS

FIG. 1 is an exploded perspective view showing the structure of main portions of a webbing retractor relating to an embodiment of the present invention.

FIG. 2 is a side view showing the structure of main portions of the webbing retractor relating to the embodiment of the present invention.

FIG. 3 is an exploded perspective view summarily showing of the overall structure of the webbing retractor relating to the embodiment of the present invention.

### BEST MODE FOR IMPLEMENTING THE INVENTION

### <Structure of the Embodiment>

First, the overall structure of a webbing retractor 10 relating to an embodiment of the present invention will be described.

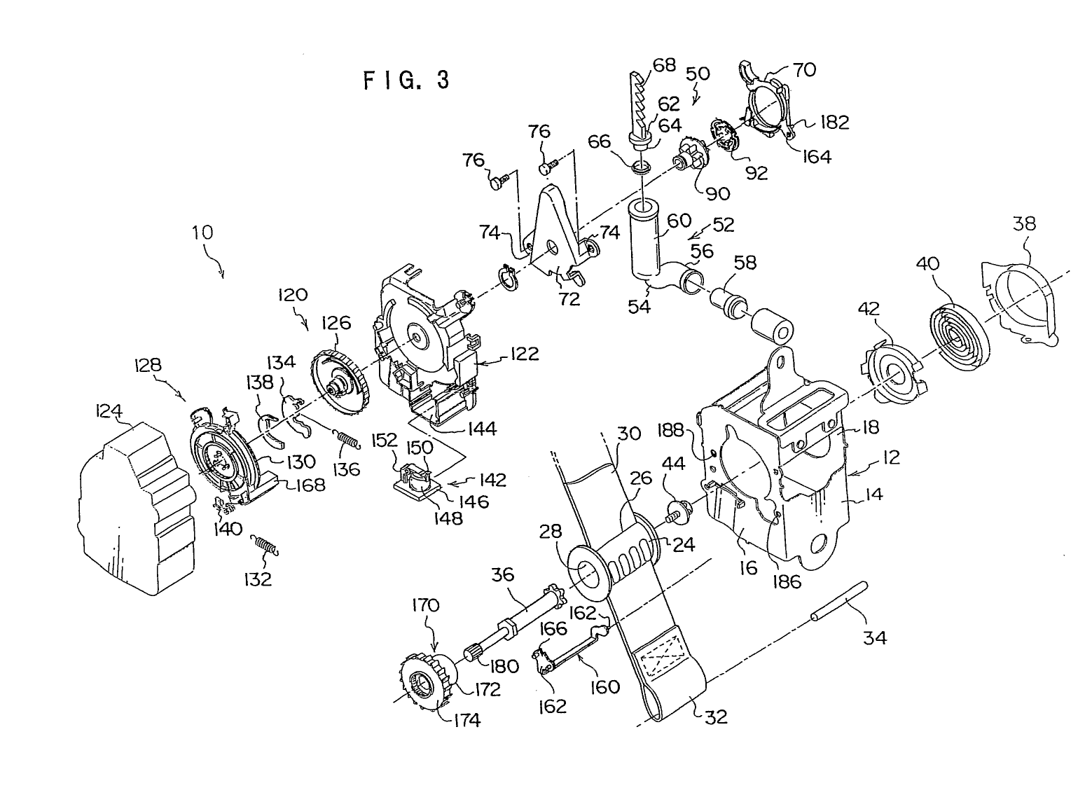

The overall structure of the webbing retractor 10 is summarily shown in an exploded perspective view in FIG. 3. As shown in FIG. 3, the webbing retractor 10 has a frame 12.

The frame 12 has a plate-shaped back plate 14 whose direction of thickness runs substantially along the left-right direction of the vehicle for example. The webbing retractor 10 is mounted to a vehicle body due to the back plate 14 being fixed to the vehicle body by a fastening means such as bolts or the like in a vicinity of the lower end portion of the center pillar for example.

A leg plate 16 is formed by being bent inwardly in the transverse direction of the vehicle (the substantially left-right direction of the vehicle), from one transverse direction end of the back plate 14 along the substantially longitudinal direction of the vehicle. A leg plate 18 is formed by being bent in the same direction as the leg plate 16, from the other transverse direction end of the back plate 14.

A spool 24 is provided between the leg plate 16 and the leg plate 18. The spool 24 is formed substantially in the shape of a cylindrical tube whose axial direction runs along the direction in which the leg plate 16 and the leg plate 18 oppose one another. An insert-through hole 26 is formed in the spool 24.

Both ends of the insert-through hole 26 open at the outer peripheral portion of the spool 24, and the configurations of these openings are shaped as slits which are long along the axial direction of the spool 24. The insert-through hole 26 is formed so as to avoid a pass-through hole 28 which passes through the axially central portion of the spool 24. The longitudinal direction proximal end side of an elongated, strip-shaped webbing belt 30 is inserted through from one opening end of the insert-through hole 26.

A tubular portion 32, which passes-through in the transverse direction, is formed at the longitudinal direction proximal end portion of the webbing belt 30. By disposing a stopper shaft 34 at the inner side of the tubular portion 32 which has passed through the insert-through hole 26, the proximal end side of the webbing belt 30 is prevented from being pulled-out from the insert-through hole 26 at the time when the webbing belt 30 is pulled toward the distal end side thereof.

Due to the spool 24 rotating in a take-up direction which is one direction around its own axis, the webbing belt 30, which is prevented from being pulled-out from the insert-through hole 26 in this way, is taken-up in layers from the proximal end side thereof onto the outer peripheral portion of the spool 24 and accommodated.

On the other hand, a rod-shaped torsion shaft 36, whose longitudinal direction runs along the axial direction of the spool 24, is disposed at the inner side of the pass-through hole 28. The torsion shaft 36 is connected to the spool 24 in a state of being prevented from rotating in directions around the axis, at the inner side of the spool 24 at the leg plate 18 side. Further, the end portion of the torsion shaft 36 at the leg plate 18 side passes through the leg plate 18 and projects-out outwardly of the frame 12.

A spring cover 38 is disposed at the outer side of the leg plate 18. The spring cover 38 is shaped as a box which is open toward the leg plate 18. The spring cover 38 is fixed to the leg plate 18 by a fastening means such as screws or the like, or by the fitting-together of fit-together claws or the like which are formed at the spring cover 38 or the leg plate 18.

A spiral spring 40 is housed at the inner side of the spring cover 38. The spiral spring 40 is a spring of a structure such that the urging force thereof gradually increases due to the spiral direction inner side end thereof being rotated and displaced in the pull-out direction, which is opposite to the aforementioned take-up direction, with respect to the spiral direction outer side end thereof. The spiral direction outer side end of the spiral spring 40 is anchored on a spring seat 42 which is provided further toward the opening side of the spring cover 38 than the spiral spring 40.

The spring seat 42 is fixed to the spring cover 38. The spiral direction outer side end of the spiral spring 40 is connected to the leg plate 18 (the frame 12) via the spring seat 42 and the spring cover 38. Further, an adapter 44 is provided in a vicinity of the spiral direction inner side end of the spiral spring 40.

The spiral direction inner side end of the spiral spring 40 is fixed to a portion of the outer periphery of the adapter 44. Further, the leg plate 18 side end portion of the torsion bar 36 which passes through the spring seat 42, is fit-together with and fixed to the axially central portion of the adapter 44.

On the other hand, a pretensioner 50 is provided at the outer side of the leg plate 16. The pretensioner 50 has a cylinder 52.

In the present embodiment, the cylinder 52 is formed by being bent appropriately at a bent portion 54, which is set at the axial direction intermediate portion of a metal pipe for example, while being plastically deformed such that the cross-sectional configuration thereof deforms appropriately while the communication at the interior thereof is maintained. The portion of the cylinder 52 at one axial direction side of the bent portion 54 is a mounting portion 56. A gas generator 58 is mounted to the opening end of the mounting portion 56.

The gas generator 58 is connected electrically or mechanically to an acceleration sensor (not shown). When the acceleration sensor detects acceleration (deceleration) in a case in which the vehicle enters a state of rapid deceleration, a gas generating agent provided within the gas generator 58 is ignited. The gas generating agent thereby combusts in an extremely short period of time, and generates gas instantaneously.

The portion of the cylinder 52 at the side of the bent portion 54 opposite the side where the mounting portion 56 is located, is a cylinder main body 60. As mentioned above, although the bent portion 54 is bent by being plastically deformed, the communication at the interior thereof is ensured. Therefore, the gas, which is generated by the gas generator 58 mounted to the mounting portion 56, is supplied to the floor portion side of the cylinder main body 60. Further, a piston 62 is provided within the cylinder main body 60.

The piston 62 is formed in the shape of a disk whose outer diameter is substantially equal to (strictly speaking, slightly smaller than) the inner diameter of the cylinder main body 60. A holding portion 64, which is shaped as a solid cylinder, is formed coaxially and integrally with the piston 62, at the end surface of the piston 62 which end surface is directed toward the floor portion of the cylinder main body 60. The outer diameter of the holding portion 64 is smaller than the diameter of the piston 62, and a sealing member 66 is fit on the outer peripheral portion of the holding portion 64.

The sealing member 66 is formed in an annular shape and is elastic. In the state in which the piston 62 is disposed at the inner side of the cylinder main body 60, the sealing member 66 elastically press-contacts both the outer peripheral portion of the holding portion 64 and the inner peripheral portion of the cylinder main body 60, and seals the region between the holding portion 64 and the cylinder main body 60. Therefore, when the gas is supplied into the cylinder main body 60 and the internal pressure of the cylinder main body 60 rises, the piston 62 slides toward the upper end side of the cylinder main body 60.

A rack bar 68 which serves as a sliding member is formed at the side of the piston 62 opposite the side at which the holding portion 64 is located (i.e., at the side of the opening end of the cylinder main body 60). The rack bar 68 is shaped as a rectangular rod which is long along the direction of opening of the cylinder main body 60. A plurality of rack teeth are formed at one transverse direction end of the rack bar 68 at uniform intervals along the longitudinal direction thereof.

A gear case 70 serving as a supporting member is provided at the leg plate 16 side in a vicinity of the opening end of the cylinder main body 60. A cover plate 72 is provided at the side of the cylinder main body 60 which is opposite the side at which the gear case 70 is located.

The cover plate 72 is formed in the shape of a box which can cover the rack bar 68, which projects-out from the cylinder main body 60, from the side of the cylinder main body 60 opposite the side where the leg plate 16 is located. The cover plate 72 is formed in a configuration so as to not interfere with at least the rack bar 68 which projects out from the opening end of the cylinder main body 60. Further, a plurality of fastening pieces 74 are formed at the outer peripheral portion of the cover plate 72. The cover plate 72 is fixed to the frame 12 by these fastening pieces 74 being fastened and fixed to the leg plate 16 by screws 76.

A holding portion (not illustrated), into which are fit the opening end of the cylinder main body 60 and the vicinity thereof, is formed at the cover plate 72. The cover plate 72 is thereby connected to the cylinder main body 60. A pinion 90 is disposed between the cover plate 72 and the gear case 70.

The pinion 90 meshes together with the rack teeth at the distal end side of the rack bar 68, and is rotatably supported at the other end of the torsion shaft 36 which passes through the leg plate 16 and the gear case 70. The pinion 90 rotates in the take-up direction due to the rack bar 68 rising.

A clutch 92 is provided at the leg plate 16 side of the pinion 90. Because the clutch 92 is rotatably supported at the torsion shaft 36, even if the torsion shaft 36 rotates, the clutch 92 does not rotate. However, the clutch 92 is engaged with the pinion 90, and when the pinion 90 rotates in the take-up direction, due to the torque thereof, a portion of the clutch 92 deforms and is connected to the torsion shaft 36.

A lock mechanism 120 is provided at the side of the leg plate 16. The lock mechanism 120 has a sensor holder 122. Portions of the sensor holder 122 are formed in concave shapes which open toward the leg plate 16 side. A portion of the cover plate 72 is positioned within a portion of the sensor holder 122 which portion opens toward the leg plate 16.

The sensor holder 122 is fixed to the leg plate 16 due to, in a state in which cylindrical-tube-shaped projections, which are formed to project from predetermined regions of the outer peripheral portion of the sensor holder 122 toward the leg plate 16, are inserted and fit-into holes formed in the leg plate 16, “plug pins” being press-fit into the projections.

A sensor cover 124 is provided at the side of the sensor holder 122 opposite the side at which the leg plate 16 is located. Fit-together claws or the like are formed at the outer peripheral portion or the like of the sensor cover 124, and the sensor cover 124 is mechanically connected to the sensor holder 122 by the fit-together claws fitting together with predetermined regions of the sensor holder 122. A tubular shaft receiving portion (not shown) is formed at the sensor cover 124. The other end portion of the torsion shaft 36, which passes through the sensor holder 122, is rotatably supported thereat.

A V gear 126 serving as a second rotating body is provided between the sensor holder 122 and the sensor cover 124. The V gear 126 is a ratchet wheel in which ratchet teeth are formed at the outer peripheral portion thereof, and is fixed coaxially and integrally to the torsion shaft 36. A sensor gear 128 serving as a first rotating body is provided at the sensor cover 124 side of the V gear 126.

A main body 130 of the sensor gear 128 is formed substantially in the shape of a disk, and the torsion shaft 36 passes coaxially therethrough. The main body 130 of the sensor gear 128 is rotatably supported at the torsion shaft 36, and one end of a return spring 132 is anchored on a portion of the main body 130. The return spring 132 is a helical tension spring, and the other end thereof is anchored at the sensor cover 124. When the sensor gear 128 rotates around the torsion shaft 36 in the pull-out direction, the return spring 132 urges the sensor gear 128 in the take-up direction.

A W pawl 134 serving as a torque transmitting means is provided at the sensor gear 128 side of the V gear 126. The W pawl 134 is supported at the V gear 126 so as to be rotatable around an axis parallel to the spool 24, at a position which is eccentric with respect to the axial center of the spool 24.

Due to the W pawl 134 rotating in the take-up direction with respect to the V gear 126, the W pawl 134 is displaced toward the rotation radial outer side of the V gear 126 with respect to the V gear 126. Due to this displacement, the W pawl 134 engages with an engaging portion (not shown) formed at the main body 130 of the sensor gear 128. In the state in which the W pawl 134 is engaged with the engaging portion of the main body 130, the torque of the V gear 126 in the pull-out direction can be transmitted to the sensor gear 128 via the W pawl 134, and the sensor gear 128 can be rotated in the pull-out direction together with the V gear 126.

A sensor spring 136 is provided at the side of the W pawl 134. The sensor spring 136 is a compression coil spring, and one end thereof is fixed to the W pawl 134. The other end of the sensor spring 136 is fixed to the V gear 126. The sensor spring 136 urges the W pawl 134 in the take-up direction around the torsion shaft 36 with respect to the V gear 126.

A W mass 138 is provided at the side of the W pawl 134 opposite the side at which the V gear 126 is located. The W mass 138 is a plate member whose direction of thickness runs along the axial direction of the torsion shaft 36, and is mounted as a weight (deadweight) of the W pawl 134.

On the other hand, an engaging claw 140 is provided at the main body 130 of the sensor gear 128. The engaging claw 140 is supported at the main body 130 so as to be able to rotate around an axis which is parallel to (the same direction as) the axial direction of the torsion shaft 36.

An acceleration sensor 142 serving as an acceleration detecting means is provided beneath the engaging claw 140. A box-shaped housing portion 144, which opens toward the sensor cover 124, is formed at the sensor holder 122 in correspondence with the acceleration sensor 142. At least a portion of the acceleration sensor 142 is housed in the housing portion 144.

The acceleration sensor 142 has a base 146. The base 146 is formed on the whole in the shape of a flat plate whose direction of thickness is the vertical direction. A curved surface, which opens upwardly, is formed at the upper side end surface of the base 146. A hard ball 148 serving as an inertial body is placed on this curved surface. A sensor claw 150 is provided above the hard ball 148.

The sensor claw 150 is rotatably supported at the upper end of a vertical wall 152 which stands erect upwardly from a portion of the outer periphery of the base 146. Due to the hard ball 148 rolling on the curved surface of the base 146 and rising, the sensor claw 150 is pushed upward. Due to the sensor claw 150 being pushed upward by the hard ball 148, the sensor claw 150 engages with the engaging claw 140 and rotates the engaging claw 140.

The V gear 126 is positioned at the side in the direction of rotation of the engaging claw 140 which is rotated due to the engagement of the sensor claw 150. In this way, the engaging claw 140 meshes together with the V gear 126. Due to the engaging claw 140 meshing together with the V gear 126, the torque of the V gear 126 in the pull-out direction is transmitted to the engaging claw 140, and accordingly to the sensor gear 128, and the sensor gear 128 rotates in the pull-out direction against the urging force of the return spring 132.

On the other hand, the lock mechanism 120 has a lock pawl 160 which serves as a locking means and structures what is called a “specific member” in the claims. The lock pawl 160 has a shaft 162. The axial direction of the shaft 162 is the direction parallel to (the same direction as) the axial direction of the spool 24. One end of the shaft 162 is rotatably supported in a shaft receiving hole (not shown) formed in the leg plate 18.

The other axial direction end portion of the shaft 162 is rotatably supported in a shaft receiving hole 164 which is formed in the gear case 70.

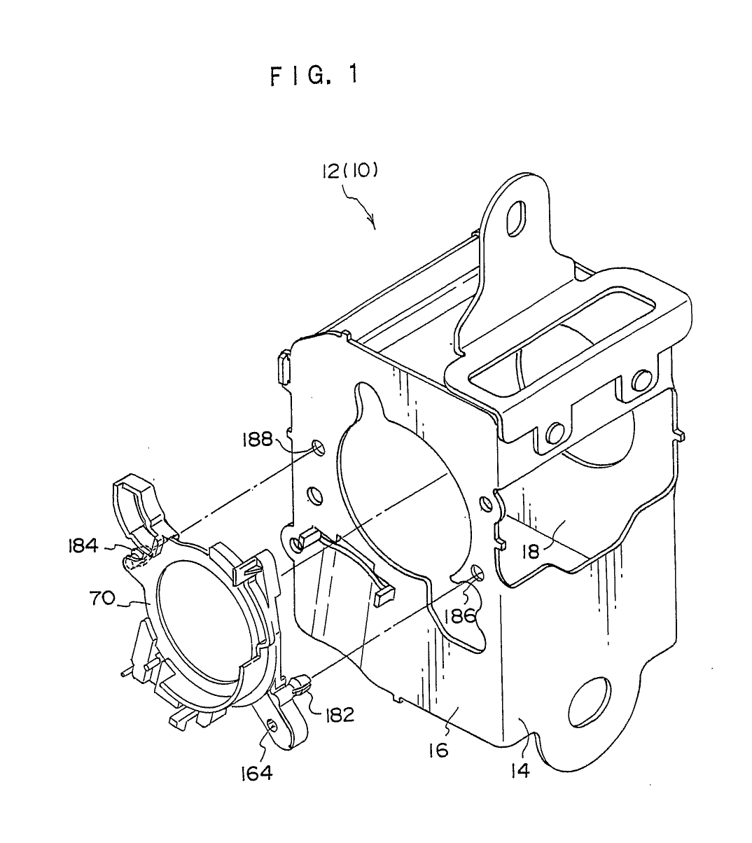

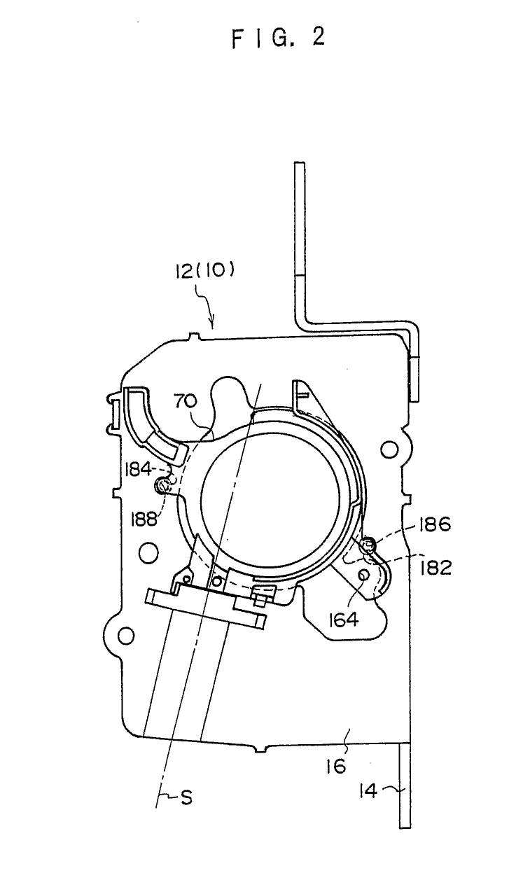

Here, as shown in FIG. 1, an engaging pin 182 serving as a connecting means is formed at the gear case 70 so as to project toward the leg plate 16. As shown in FIG. 2, when the gear case 70 is viewed along the axial direction of the spool 24, the engaging pin 182 is formed so as to be positioned at the side of a sliding locus S of the rack bar 68 of the pretensioner 50.

Further, as shown in FIG. 1, an engaging pin 184 serving as a connecting means is formed at the gear case 70 so as to project toward the leg plate 16. As shown in FIG. 2, the engaging pin 184 is formed so as to be positioned at the side opposite the engaging pin 182, with the sliding locus S of the rack bar 68 of the pretensioner 50 therebetween.

As shown in FIG. 1 and FIG. 2, the engaging pin 184 is provided so as to be displaced further toward the upper side of the frame 12, i.e., further toward the side in the sliding direction of the rack bar 68 at the time when the piston 62 slides toward the upper end side of the cylinder main body 60, than the engaging pin 182.

Engaging holes 186, 188 are formed in the leg plate 16 in correspondence with the engaging pins 182, 184, respectively. The gear case 70 is fixed to the leg plate 16 due to the engaging pin 182 fitting together with the engaging hole 186 and the engaging pin 184 fitting together with the engaging hole 188.

As shown in FIG. 3, a pawl portion 166 is formed at the axial direction other end side of the shaft 162 whose other end is supported at the above-described gear case 70. The pawl portion 166 is a plate-shaped member whose direction of thickness runs along the axial direction of the shaft 162. External ratchet teeth are formed at a portion of the outer periphery of the pawl portion 166.

A lock base 170 is provided at the side of the pawl portion 166 along the rotation radial direction of the shaft 162. The lock base 170 has a fit-in portion 172. The fit-in portion 172 is formed in the shape of a cylinder, and is fit and inserted in the other end portion of the pass-through hole 28 of the spool 24, rotatably and coaxially with respect to the spool 24.

The torsion shaft 36 coaxially passes through the fit-in portion 172, and accordingly the lock base 170, in a state in which rotation is prevented. The fit-in portion 172 and accordingly the lock base 170 rotate integrally and coaxially with respect to the torsion shaft 36.

A ratchet portion 174 is formed integrally with the leg plate 16 side of the fit-in portion 172. The ratchet portion 174 is formed coaxially with respect to the fit-in portion 172. Ratchet teeth are formed intermittently at the outer peripheral portion of the ratchet portion 174.

Due to the shaft 162 rotating in the take-up direction, the ratchet teeth of the pawl portion 166 of the lock pawl 160 mesh together with the ratchet teeth of the ratchet portion 174. In this state in which the pawl portion 166 and the ratchet portion 174 are meshed-together, rotation of the ratchet portion 174, and accordingly the lock base 170, in the pull-out direction is restricted.

Further, a pressing portion 168 serving as a connecting member is provided at the main body 130 of the sensor gear 128, in correspondence with the pawl portion 166. The pressing portion 168 is formed integrally with the engaging claw 140. When the engaging claw 140 is pushed upward by the hard ball 148 and rotated, the pressing portion 168 rotates integrally therewith, and presses the pawl portion 166, and rotates the lock pawl 160 in the take-up direction.

### <Operation and Effects of the Embodiment>

In the present webbing retractor 10, when the webbing belt 30, which is in a state of being taken-up on the spool 24, is pulled toward the distal end side thereof against the urging force of the spiral spring 40, the spool 24 rotates in the pull-out direction while the webbing belt 30 is pulled-out. The webbing belt 30 which is pulled-out in this way, is applied around the body of a vehicle occupant. Due to the tongue plate, which is provided at a longitudinal direction intermediate portion of the webbing belt 30 for example, being held by a buckle device provided at the side of the vehicle seat, the webbing belt 30 is set in a state of being applied to the body of the vehicle occupant, and the body of the vehicle occupant is restrained by the webbing belt 30.

In this applied state of the webbing belt 30, when the vehicle enters into a state of rapid deceleration and the acceleration sensor of the pretensioner 50 detects this state of rapid deceleration of the vehicle, the gas generator 58 operates, and the gas generating agent provided within the gas generator 58 is ignited. The ignited gas generating agent combusts in an extremely short period of time, and instantaneously generates gas.

The gas, which is generated by the gas generator 58 in this way, is supplied to the interior of the cylinder main body 60 from the mounting portion 56, and causes the internal pressure of the cylinder main body 60 to rise suddenly. Due to the internal pressure of the cylinder main body 60 rising, the piston 62 rises, and accompanying this, the rack bar 68 rises. The rack bar 68 which rises rotates the pinion 90 in the take-up direction.

Due to the pinion 90 rotating in the take-up direction, a portion of the clutch 92 deforms, and the pinion 90 is connected to the torsion shaft 36. Due to the pinion 90 connecting with the torsion shaft 36 in this way, the torque of the pinion 90 is transmitted to the torsion shaft 36, and the torsion shaft 36, and accordingly the spool 24, is forcibly rotated in the take-up direction.

Due to the spool 24 being rotated in the take-up direction in this way, the webbing belt 30 is taken-up, and the slight slack or the like of the webbing belt 30 is eliminated. In this way, the restraining force of the webbing belt 30 with respect to the body of the vehicle occupant increases, and inertial movement of the body of the vehicle occupant substantially toward the front of the vehicle can be suppressed.

Further, in the aforementioned state of a rapid deceleration of the vehicle, when the hard ball 148 rolls, the sensor claw 150 is pushed upward by the hard ball 148. The sensor claw 150, which is pushed upward in this way, engages with the engaging claw 140 of the sensor gear 128 and rotates the engaging claw 140. By rotating, the engaging claw 140 meshes together with the V gear 126.

On the other hand, when the body of the vehicle occupant inertially moves substantially toward the front of the vehicle in the state of a rapid deceleration of the vehicle, the webbing belt 30 is suddenly pulled-out by the body of the vehicle occupant. When the webbing belt 30 is suddenly pulled-out in this way, the spool 24, and accordingly the V gear 126, suddenly rotates in the pull-out direction.

When the V gear 126 suddenly rotates in the pull-out direction, the W pawl 134 attempts to rotate in the pull-out direction together with the V gear 126. However, because the W mass 138 is provided at the W pawl 134, the W pawl 134, due to inertia, attempts to remain at that position without rotating. In this way, relative movement against the urging force of the sensor spring 136 arises between the V gear 126, which rotates in the pull-out direction, and the W pawl 134, which is attempting to stop.

Due to the W pawl 134 moving relatively to the V gear 126 in this way, the W pawl 134 engages with the sensor gear 128. Due to the W pawl 134 engaging with the sensor gear 128, the sensor gear 128 is connected to the V gear 126 via the W pawl 134.

In the state in which the sensor gear 128 is connected to the V gear 126 via the engaging pawl 140 or the W pawl 134 in this way, when the webbing belt 30 is pulled-out by the body of the vehicle occupant and the spool 24 rotates in the pull-out direction, the sensor gear 128 rotates in the pull-out direction together with the V gear 126. When the sensor gear 128 rotates by a given angle in the pull-out direction against the urging force of the return spring 132, the pushing portion 168 which is integral with the engaging claw 140 pushes the pawl portion 166 of the lock pawl 160, and rotates the pawl portion 166 around the shaft 162.

When the pawl portion 166 rotates around the shaft 162 in this way, the pawl portion 166 meshes together with the ratchet portion 174 of the lock base 170, and rotation of the lock base 170, and accordingly the spool 24, in the pull-out direction is restricted. In this way, the body of the vehicle occupant, which is attempting to inertially move substantially toward the front of the vehicle, can be reliably restrained and held by the webbing belt 30.

In the present webbing retractor 10, in the present embodiment, the engaging pins 182, 184 for fixing the gear case 70 to the leg plate 16 are provided at the both sides with the sliding locus S of the rack bar 68 therebetween, as described above. Therefore, in a case in which the gear case 70 receives external force with respect to the transverse direction of the leg plate 16 (the direction in which the leg plate 16 extends from the back plate 14, and the direction opposite thereto), the engaging pins 182, 184, which are fit-together with the engaging holes 186, 188, sturdily resist this external force.

Further, the engaging pin 184 is provided so as to be displaced further toward the sliding direction side of the rack bar 68 than the engaging pin 182. Therefore, in a case in which the gear case 70 receives external force along the sliding direction of the rack bar 68, the engaging pins 182, 184, which are fit-together with the engaging holes 186, 188, sturdily resist this external force.

In this way, for example, in a case in which the pretensioner 50 operates, and the impact at the time when the rack bar 68 suddenly rises is transmitted to the gear case 70, and the gear case 70 attempts to be displaced in the transverse direction of the leg plate 16 or the sliding direction of the rack bar 68 due to this impact, the engaging pins 182, 184, which are fit-together with the engaging holes 186, 188, soundly restrict the displacement of the gear case 70.

Therefore, in the present embodiment, changes in the position of supporting the shaft 162 of the lock pawl 160 which is supported at the gear case 70, are prevented or are effectively suppressed. In this way, the shaft 162 can be rotated smoothly without tension or the like arising at the shaft 162. Thus, in the present embodiment, the pawl portion 166 can be smoothly moved in directions of approaching and moving away.

Further, due to changes in the supporting position of the shaft 162 being prevented or effectively suppressed as described above, changes in the relative positional relationship between the ratchet portion 174 and the pawl portion 166 in the state in which the pawl portion 166 is not rotating can be prevented or effectively suppressed.

In this way, in the present embodiment, changes in the relative positional relationship of the pawl portion 166 with respect to the ratchet portion 174 can be prevented. Further, by making the pawl portion 166 able to smoothly move in directions of approaching and moving away, the pawl portion 166 can smoothly and reliably be made to mesh together with the ratchet portion 174, and further, this meshing can be smoothly and reliably cancelled.

Moreover, in the present embodiment, by setting the positional relationship between the engaging pin 182 and the engaging pin 184 as described above, displacement of the gear case 70 with respect to the leg plate 16 can be prevented or reliably suppressed, even if the mechanical strength of the gear case 70 or the engaging pins 182, 184 is not particularly improved. In this way, the gear case 70, including the engaging pins 182, 184, can be formed of a material having a mechanical strength which is relatively lower than that of a metal material, such as a synthetic resin material or the like. The materials costs and the machining costs can be made to be less expensive, and the structure can be made to be lighter-weight.

Note that the present embodiment is a structure in which the gear case 70, which serves as the supporting member structuring the present invention, supports the lock pawl 160. However, the member which the supporting member structuring the present invention supports is not limited to the lock pawl 160, and may be another member.

### INDUSTRIAL APPLICABILITY

The webbing retractor relating to the present invention can suppress or effectively suppress changes in the assembled position of a supporting member with respect to a frame. Changes in the supporting position of a specific member, which is supported by the supporting member, can thereby be suppressed or effectively suppressed. Moreover, such effects can be achieved by the pair of connecting means, even if the mechanical strength of the supporting member is not improved in particular. Thus, the supporting member can be made to be lighter-weight.

1. A webbing retractor comprising:
a spool supported one of directly and indirectly at a frame, a longitudinal direction proximal end side of webbing belt being anchored on the spool, and the spool taking-up the webbing belt by rotating in a take-up direction which is one direction around an axis of the spool;
a pretensioner having at least a sliding member which can slide in a predetermined sliding direction which intersects an axial direction of the spool, and due to the sliding member sliding in the sliding direction, the sliding member connects one of directly and indirectly to the spool and rotates the spool in the take-up direction, the pretensioner causing the sliding member to slide in the sliding direction in a state of rapid deceleration of a vehicle;
a supporting member provided at a side of a sliding locus (S) of the sliding member along the axial direction of the spool, and supporting a specific member which finally stops rotation of the spool; and
a pair of connecting means, one of the connecting means being provided at a side of the sliding locus along a direction orthogonal to both the axial direction of the spool and the sliding direction, and another of the connecting means being provided at a side of the sliding locus opposite a side at which the one of the connecting means is located, and at a position which is displaced, in the sliding direction of the sliding member, with respect to the one of the connecting means, the connecting means mechanically connecting the supporting member to the frame.

2. The webbing retractor of claim 1, wherein the connecting means are formed integrally with the supporting member.

3. The webbing retractor of claim 2, wherein the connecting means are a pair of engaging pins, and the engaging pins can fix the supporting member to the frame by fitting-together with engaging holes formed in the frame respectively.

4. The webbing retractor of claim 1, wherein the connecting means are a pair of engaging pins, and the engaging pins are structured so as to be able to fix the supporting member to the frame by fitting-together, via the supporting member, with engaging holes formed in the frame respectively.

5. The webbing retractor of claim 2, wherein the connecting means fix the supporting member such that the supporting member is unable to rotate with respect to the frame.

6. The webbing retractor of claim 1, wherein the supporting member is formed of a material whose mechanical strength is relatively low.

7. The webbing retractor of claim 1, wherein the connecting member is formed of a material whose mechanical strength is relatively low.

8. A webbing retractor comprising:
a spool supported one of directly and indirectly at a frame, a longitudinal direction proximal end side of webbing belt being anchored on the spool, and the spool taking-up the webbing belt by rotating in a take-up direction which is one direction around an axis of the spool;
a pretensioner having at least a sliding member which can slide in a predetermined sliding direction which intersects an axial direction of the spool, and due to the sliding member sliding in the sliding direction, the sliding member connects one of directly and indirectly to the spool and rotates the spool in the take-up direction, the pretensioner causing the sliding member to slide in the sliding direction in a state of rapid deceleration of a vehicle;
a supporting member mounted to the frame and supporting a specific member which finally stops rotation of the spool, at a side of a sliding locus (S) of the sliding member along the axial direction of the spool; and
at least two connecting means mounting the supporting member to the frame,
wherein the connecting means fix the supporting member to the frame such that the supporting member does not rotate with respect to the frame.

9. The webbing retractor of claim 8, wherein one of the connecting means is provided at one side of the sliding locus along a direction orthogonal to both the axial direction of the spool and the sliding direction, and another one of the connecting means is provided at a side of the sliding locus opposite a side at which the one of the connecting means is located, and at a position which is displaced, in the sliding direction of the sliding member, with respect to the one of the connecting means.

10. The webbing retractor of claim 8, wherein the connecting means are formed integrally with the supporting member.

11. The webbing retractor of claim 10, wherein the connecting means are a pair of engaging pins, and the engaging pins are structured so as to be able to fix the supporting member to the frame by fitting-together with engaging holes formed in the frame respectively.

12. The webbing retractor of claim 8, wherein the connecting means are a pair of engaging pins, and the engaging pins are structured so as to be able to fix the supporting member to the frame by fitting-together, via the supporting member, with engaging holes formed in the frame respectively.

13. The webbing retractor of claim 8, wherein the supporting member is formed of a material whose mechanical strength is relatively low.

14. The webbing retractor of claim 8, wherein the connecting member is formed of a material whose mechanical strength is relatively low.
